(19) United States
(12) Patent Application Publication
(10) Pub. No.: US 2023/0275284 A1
(43) Pub. Date: Aug. 31, 2023

(54) BATTERY PACK

(71) Applicant: Prime Planet Energy & Solutions, Inc., Tokyo (JP)

(72) Inventors: Naotake YOSHIDA, Himeji-shi (JP); Satoru MATSUYAMA, Kasai-shi (JP)

(21) Appl. No.: 18/173,801

(22) Filed: Feb. 24, 2023

(30) Foreign Application Priority Data
Feb. 25, 2022 (JP) 2022-028194

(51) Int. Cl. H01M 10/6556; H01M 50/204; H01M 10/613; H01M 10/6554

(52) U.S. Cl. CPC H01M 10/6556; H01M 50/204; H01M 10/613; H01M 10/6554; H01M 10/6567

(57) ABSTRACT

A battery pack includes: a plurality of battery cells; a case member including an inner space in which the plurality of battery cells are accommodated, a cooling plate provided with a coolant path through which a coolant flows, and a side surface portion defining the inner space together with the cooling plate; an entrance portion for the coolant into the coolant path of the cooling plate; an exit portion for the coolant from the coolant path of the cooling plate; and a coolant tube connected to the entrance portion and the exit portion. The cooling plate includes a first portion facing the inner space and a second portion protruding on an outer side with respect to the side surface portion of the case member. The entrance portion and the exit portion for the coolant are connected to the second portion.

This nonprovisional application is based on Japanese Patent Application No. 2022-028194 filed on Feb. 25, 2022, with the Japan Patent Office, the entire contents of which are hereby incorporated by reference.

### BACKGROUND OF THE INVENTION

### Field of the Invention

The present technology relates to a battery pack.

### Description of the Background Art

Conventionally, a cooling plate is provided in a battery pack and a coolant is caused to flow in the cooling plate, thereby cooling battery cells accommodated in a case member. For example, WO 2015/146387 describes a battery cooling structure that uses a first coolant having a relatively large specific gravity and a second coolant having a relatively small specific gravity.

### SUMMARY OF THE INVENTION

When a coolant path through which a coolant such as water flows is introduced into an inner space of a case member of a battery pack, if leakage occurs at a joint portion or the like, the coolant enters the inside of the case. There is still room for improvement in the conventional battery pack from the viewpoint of avoiding the coolant from entering the inside of the case.

It is an object of the present technology to provide a battery pack in which coolant can be prevented from entering inside of a case member.

A battery pack according to the present technology includes: a plurality of battery cells; a case member including an inner space in which the plurality of battery cells are accommodated, a cooling plate provided with a coolant path through which a coolant flows, and a side surface portion defining the inner space together with the cooling plate; an entrance portion for the coolant into the coolant path of the cooling plate; an exit portion for the coolant from the coolant path of the cooling plate; and a coolant tube connected to the entrance portion and the exit portion. The cooling plate includes a first portion facing the inner space and a second portion protruding on an outer side with respect to the side surface portion of the case member. The entrance portion and the exit portion for the coolant are connected to the second portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a battery cell.

FIG. 2 is a perspective view showing battery cells and a case member that accommodates the battery cells.

FIG. 3 is a perspective view showing the case member (except for a cover portion) of a battery pack.

FIG. 4 is an external view of the battery pack.

FIG. 5 is a diagram showing modifications of an entrance portion and an exit portion for a coolant into and from a coolant path of a cooling plate.

FIG. 6 is a diagram showing an arrangement of the coolant path in the cooling plate.

FIG. 7 is a cross sectional view along VII-VII in FIG. 6.

FIG. 8 is an enlarged view of a supporting portion for a coolant tube.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium ion battery.

In the present specification, the term “battery cell” is not necessarily limited to a prismatic battery cell and may include a cell having another shape, such as a cylindrical battery cell, a pouch battery cell, or a blade battery cell. The “battery cell” can be mounted on vehicles such as a hybrid electric vehicle (BEV), a plug-in hybrid electric vehicle (PHEV), and a battery electric vehicle (BEV). It should be noted that the use of the “battery cell” is not limited to the use in a vehicle.

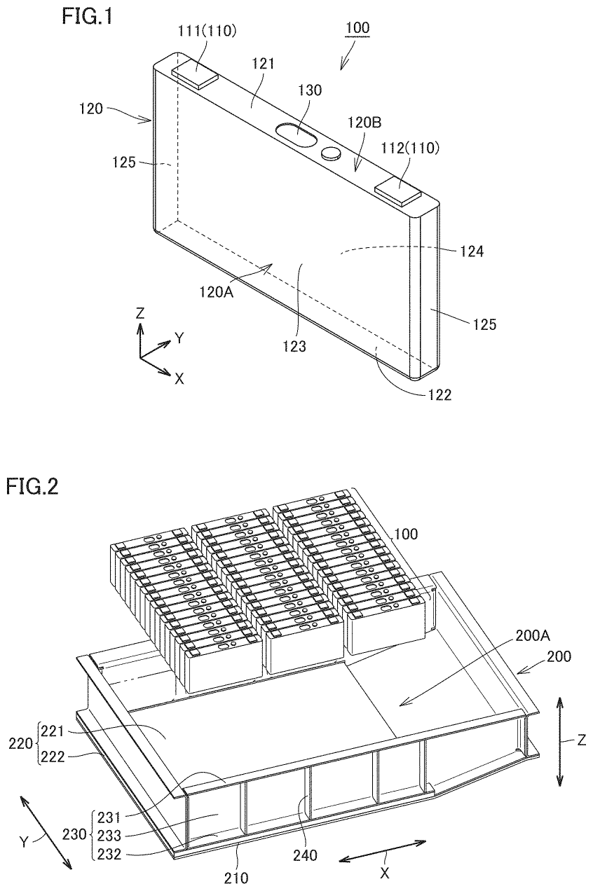

FIG. 1 is a perspective view showing a battery cell 100. As shown in FIG. 1, battery cell 100 has a prismatic shape. Battery cell 100 has electrode terminals 110, a housing 120, and a gas-discharge valve 130.

Electrode terminals 110 are formed on housing 120. Electrode terminals 110 have a positive electrode terminal 111 and a negative electrode terminal 112 arranged side by side along an X axis direction (second direction) orthogonal to a Y axis direction (first direction). Positive electrode terminal 111 and negative electrode terminal 112 are provided to be separated from each other in the X axis direction.

Housing 120 has a rectangular parallelepiped shape and forms an external appearance of battery cell 100. Housing 120 includes: a case body 120A that accommodates an electrode assembly (not shown) and an electrolyte solution (not shown); and a sealing plate 120B that seals an opening of case body 120A. Sealing plate 120B is joined to case body 120A by welding.

Housing 120 has an upper surface 121, a lower surface 122, a first side surface 123, a second side surface 124, and two third side surfaces 125.

Upper surface 121 is a flat surface orthogonal to a Z axis direction (third direction) orthogonal to the Y axis direction and the X axis direction. Electrode terminals 110 are disposed on upper surface 121. Lower surface 122 faces upper surface 121 along the Z axis direction.

Each of first side surface 123 and second side surface 124 is constituted of a flat surface orthogonal to the Y axis direction. Each of first side surface 123 and second side surface 124 has the largest area among the areas of the plurality of side surfaces of housing 120. Each of first side surface 123 and second side surface 124 has a rectangular shape when viewed in the Y axis direction. Each of first side surface 123 and second side surface 124 has a rectangular shape in which the X axis direction corresponds to the long-side direction and the Z axis direction corresponds to the short-side direction when viewed in the Y axis direction.

A plurality of battery cells 100 are stacked such that first side surfaces 123 of battery cells 100, 100 adjacent to each other in the Y direction face each other and second side surfaces 124 of battery cells 100, 100 adjacent to each other in the Y axis direction face each other. Thus, positive electrode terminals 111 and negative electrode terminals 112 are alternately arranged in the Y axis direction in which the plurality of battery cells 100 are stacked.

Gas-discharge valve 130 is provided in upper surface 121. When the temperature of battery cell 100 is increased in an abnormal manner (thermal runaway) and internal pressure of housing 120 becomes more than or equal to a predetermined value due to gas generated inside housing 120, gas-discharge valve 130 discharges the gas to outside of housing 120.

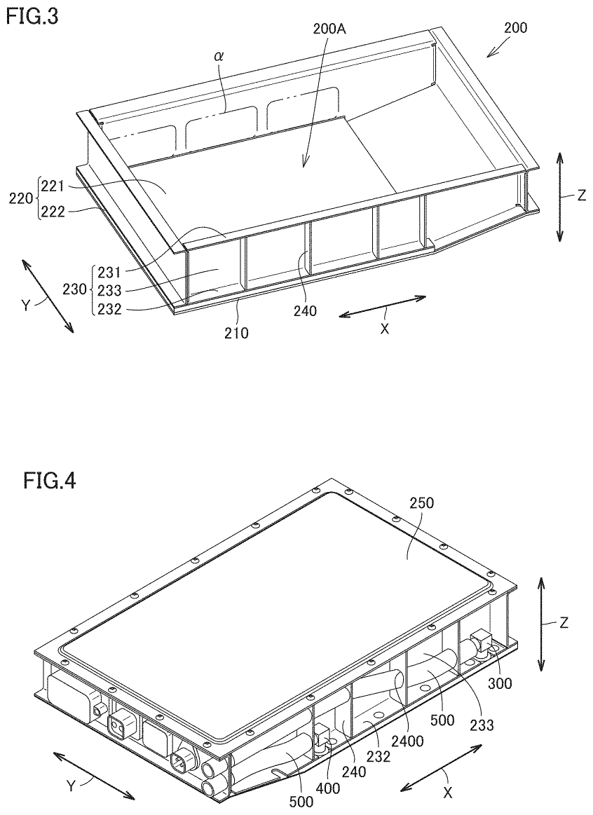

Each of FIGS. 2 and 3 is a perspective view showing case member 200 that accommodates battery cells 100. In each of FIGS. 2 and 3, for convenience of illustration, a below-described cover portion of case member 200 is not shown.

As shown in FIGS. 2 and 3, case member 200 includes an inner space 200A, a bottom surface member 210, a cooling plate 220, a side surface member 230, and reinforcing ribs 240.

Inner space 200A accommodates stacks (battery assemblies) of the plurality of battery cells 100 stacked in the Y axis direction. The battery assemblies are arranged in three rows in the X axis direction. Cooling plate 220 and side surface member 230 define inner space 200A.

Bottom surface member 210 and cooling plate 220 constitute a bottom portion of case member 200. Cooling plate 220 is provided on bottom surface member 210. Cooling plate 220 includes: a first portion 221 facing inner space 200A; and a second portion 222 located on an outer side with respect to first portion 221 and not facing inner space 200A.

Side surface member 230 includes upper flange portions 231 (first flange), lower flange portions 232 (second flange), and side surface portions 233 (frame portion). Second portion 222 of cooling plate 220 is sandwiched between each lower flange portion 232 of side surface member 230 and bottom surface member 210. Side surface portions 233 of side surface member 230 constitute side surfaces of case member 200. Side surface portions 233 include: portions each extending in a direction orthogonal to the Y axis direction; and portions each extending in a direction orthogonal to the X axis direction. Side surface portions 233 connect upper flange portions 231 and lower flange portions 232. Upper flange portions 231 (first flange), lower flange portions 232 (second flange), and side surface portions 233 (frame portion) constitute a U-shaped cross section. Side surface portions 233, which are located on both sides in the Y axis direction with respect to the stacks (including separators) of battery cells 100 and extend in the direction orthogonal to the Y axis direction, directly support the stacks of battery cells 100 (Cell-to-Pack structure). At portions a of side surface portions 233 in FIG. 3, the stacks of battery cells 100 are in abutment with side surface portions 233.

It should be noted that case member 200 is not limited to one in which side surface portions 233 directly support the stacks of battery cells 100, and may be one (Cell-Module-Pack structure) in which a battery module including the plurality of battery cells 100 is accommodated.

Reinforcing ribs 240 are provided on side surface portions 233 extending in the direction orthogonal to the Y axis direction. Reinforcing ribs 240 may be provided on side surface portions 233 extending in the direction orthogonal to the X axis direction. Reinforcing ribs 240 are provided to extend in the Z axis direction. Reinforcing ribs 240 may extend in a direction obliquely intersecting the Z axis direction.

On each of side surface portions 233 extending in the direction orthogonal to the Y axis direction, the plurality of reinforcing ribs 240 are provided side by side in the X axis direction. One reinforcing rib 240 may be provided.

Each of reinforcing ribs 240 extends on a whole of side surface portion 233 in the Z axis direction. Reinforcing rib 240 may be provided on a part of side surface portion 233 in the Z axis direction.

Lower flange portion 232 is in abutment with second portion 222 of cooling plate 220. Upper flange portion 231 is formed at an upper end portion of side surface member 230, i.e., an end portion opposite to cooling plate 220 in the Z axis direction. Upper flange portion 231 is separated from second portion 222 of cooling plate 220 and lower flange portion 232 along the Z axis direction and is formed in parallel with second portion 222 and lower flange portion 232. Upper flange portion 231 protrudes from side surface portion 233 in the same direction as second portion 222 of cooling plate 220 and lower flange portion 232. Second portion 222 of cooling plate 220 protrudes on an outer side with respect to side surface portion 233 of side surface member 230.

Reinforcing rib 240 is formed to extend from upper flange portion 231 to reach lower flange portion 232. Reinforcing rib 240 may be composed of the same material as a material of side surface member 230, or may be composed of a material different from the material of side surface member 230. Reinforcing rib 240 may be composed of, for example, a steel plate, aluminum, or resin. Reinforcing rib 240 is joined to upper flange portion 231 and lower flange portion 232. This joining is attained by welding or the like, for example.

FIG. 4 is an external view of the battery pack. As shown in FIG. 4, a cover member 250 is assembled to side surface member 230 to seal inner space 200A of case member 200. The battery pack includes an entrance portion 300, an exit portion 400, and coolant tubes 500. A coolant is supplied from entrance portion 300 through coolant tube 500 to a coolant path formed inside cooling plate 220, and the coolant is discharged from exit portion 400 through coolant tube 500. Water is used as the coolant, but it is not limited thereto.

Each of coolant tubes 500 is provided to extend along side surface portion 233. Coolant tubes 500 are supported by supporting portions 2400 provided at reinforcing ribs 240. Each of supporting portions 2400 may be constituted of a through hole provided in reinforcing rib 240.

FIG. 5 is a diagram showing modifications of entrance portion 300 and exit portion 400. In the example shown in FIG. 4, coolant tubes 500 are connected to entrance portion 300 and exit portion 400 in an oblique direction, whereas in the example shown in FIG. 5, coolant tubes 500 are curved in the vicinities of entrance portion 300 and exit portion 400, and coolant tubes 500 are connected to entrance portion 300 and exit portion 400 in the Z axis direction. It should be noted that entrance portion 300 and exit portion 400 may be each formed to have a substantially L shape, and coolant tubes 500 may be connected to entrance portion 300 and exit portion 400 in a direction obliquely intersecting the Z axis.

In each of the examples shown in FIGS. 4 and 5, coolant tubes 500 extend on an X-Z plane in a direction obliquely intersecting the X axis and the Z axis. An inclination angle of each of coolant tubes 500 with respect to each of the X axis and the Z axis may be unchanged on side surface portion 233 or may be changed on side surface portion 233.

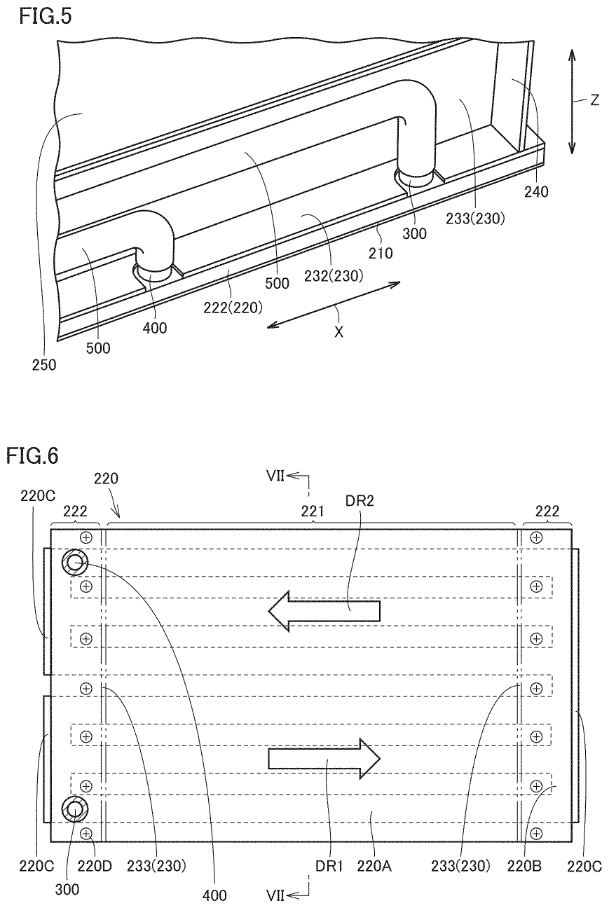

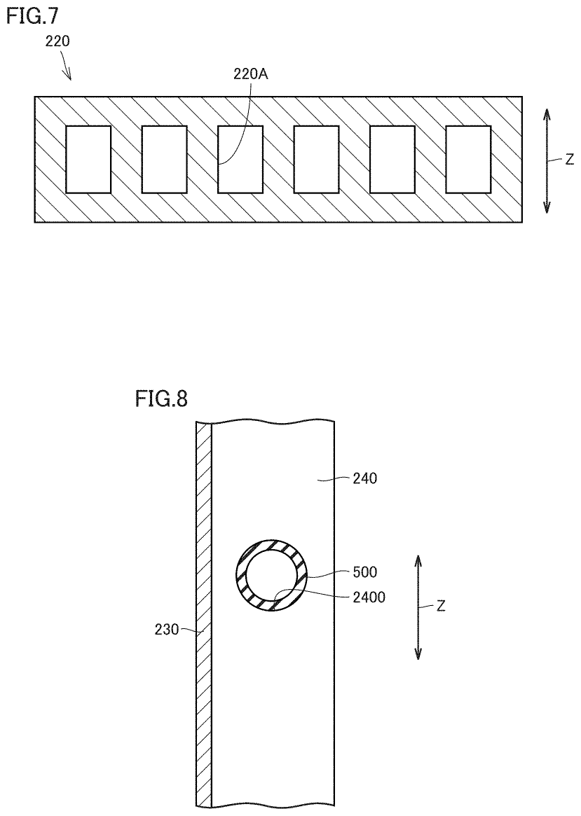

FIG. 6 is a diagram showing an arrangement of the coolant path in the cooling plate. FIG. 7 is a cross sectional view along VII-VII in FIG. 6. As shown in FIG. 6, the coolant having flowed into cooling plate 220 from entrance portion 300 disposed in second portion 222 of cooling plate 220 flows in a first flow path 220A in a direction of arrow DR1, passes through first portion 221 of cooling plate 220, and then reaches second portion 222 located opposite to entrance portion 300.

In second portion 222 of cooling plate 220, a second flow path 220B is formed to intersect (orthogonal to) first flow path 220A. A curved portion is formed between first flow path 220A and second flow path 220B. That is, the coolant path of cooling plate 220 has a curved portion located at second portion 222. A cover 220C is joined thereto on the outer side with respect to second flow path 220B by welding. Thus, the coolant path of cooling plate 220 is closed and the curved portion is formed. Cooling plate 220 is joined to lower flange portion 232 of side surface member 230 using bolts 220D.

The coolant having been turned around (U-turned) at second portion 222 of cooling plate 220 flows in first flow path 220A in a direction of arrow DR2, passes through first portion 221 of cooling plate 220, and then reaches exit portion 400 located at second portion 222 on the same side as entrance portion 300.

As shown in FIG. 7, cooling plate 220 may be formed by processing an extruded material provided with communication holes to serve as first flow path 220A.

FIG. 8 is an enlarged view of supporting portion 2400 for coolant tube 500. In the example of FIG. 8, supporting portion 2400 is constituted of a through hole having a substantially circular shape and provided in reinforcing rib 240. The shape of the through hole can be appropriately changed. A cushion material may be provided at a portion of contact between supporting portion 2400 and coolant tube 500.

In the battery pack according to the present embodiment, since entrance portion 300 and exit portion 400 are provided at second portion 222 that does not face inner space 200A of case member 200, the coolant can be prevented from entering inner space 200A of case member 200 even when leakage occurs at entrance portion 300 and exit portion 400. Further, since coolant tube 500 is supported by reinforcing rib 240, unintended deformation of coolant tube 500 can be suppressed. As a result, coolant tube 500 can be suppressed from being broken. It should be noted that reinforcing rib 240 may not be provided necessarily.

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A battery pack comprising:
a plurality of battery cells;
a case member including an inner space in which the plurality of battery cells are accommodated, a cooling plate provided with a coolant path through which a coolant flows, and a side surface portion defining the inner space together with the cooling plate;
an entrance portion for the coolant into the coolant path of the cooling plate;
an exit portion for the coolant from the coolant path of the cooling plate; and
a coolant tube connected to the entrance portion and the exit portion, wherein
the cooling plate includes a first portion facing the inner space and a second portion protruding on an outer side with respect to the side surface portion of the case member, and
the entrance portion and the exit portion for the coolant are connected to the second portion.

2. The battery pack according to claim 1, wherein the coolant tube has a portion extending along the side surface portion.

3. The battery pack according to claim 1, wherein
the side surface portion of the case member has a reinforcing rib provided on an side opposite to the inner space, and
the reinforcing rib includes a supporting portion that supports the coolant tube.

4. The battery pack according to claim 3, wherein the reinforcing rib is composed of the same material as a material of the side surface portion of the case member.

5. The battery pack according to claim 3, wherein
the plurality of battery cells are arranged in a first direction and each include a plurality of electrode terminals disposed side by side in a second direction orthogonal to the first direction, and
the reinforcing rib extends in a third direction orthogonal to the first direction and the second direction or in a direction obliquely intersecting the third direction.

6. The battery pack according to claim 5, wherein the reinforcing rib is provided at the side surface portion of the case member located on each of both sides with respect to the plurality of battery cells in the first direction.

7. The battery pack according to claim 6, wherein the side surface portion of the case member supports the plurality of battery cells in the first direction.

8. The battery pack according to claim 1, wherein
the coolant tube has a portion extending along the side surface portion,
the side surface portion of the case member has a reinforcing rib provided on an side opposite to the inner space, and
the reinforcing rib includes a supporting portion that supports the coolant tube.

9. The battery pack according to claim 8, wherein the reinforcing rib is composed of the same material as a material of the side surface portion of the case member.

10. The battery pack according to claim 8, wherein
the plurality of battery cells are arranged in a first direction and each include a plurality of electrode terminals disposed side by side in a second direction orthogonal to the first direction, and
the reinforcing rib extends in a third direction orthogonal to the first direction and the second direction or in a direction obliquely intersecting the third direction.

11. The battery pack according to claim 10, wherein the reinforcing rib is provided at the side surface portion of the case member located on each of both sides with respect to the plurality of battery cells in the first direction.

12. The battery pack according to claim 11, wherein the side surface portion of the case member supports the plurality of battery cells in the first direction.

13. The battery pack according to claim 1, wherein the coolant path of the cooling plate has a curved portion located at the second portion.
